(19) United States
(12) Patent Application Publication
(10) Pub. No.: US 2003/0171035 A1
(43) Pub. Date: Sep. 11, 2003

(54) Connecting structure for USB

(75) Inventor: Jin O Yoo, Suwon (KR)

Correspondence Address: LOWE HAUPTMAN GOPSTEIN, GILMAN & BERNER, LLP, Suite 310, 1700 Diagonal Road, Alexandria, VA, 22314, US

(73) Assignee: Samsung Electro-Mechanics Co., Ltd.

(21) Appl. No.: 10/159,107

(22) Filed: Jun. 3, 2002

(30) Foreign Application Priority Data
Mar. 11, 2002 (KR) 2002-12854

(51) Int. Cl. H01R 25/00

(52) U.S. Cl. 439/638

(57) ABSTRACT

A connecting structure between a USB connector plugged into USB ports of a computer unit and a USB device, which enables a printed circuit board of the USB device and the USB connector to carry out their function even in the reversed position, is disclosed. The connecting structure includes a printed circuit to be electrically connected to the computer unit, which is provided at its both surfaces with signal terminals such that the printed circuit board has the same arrangement of the signal terminals, regardless of the position of the USB device, and a USB connector which is inserted into the USB device and a USB port of the computer unit at its both ends, the USB connector having conductive strips corresponding to the signal terminals of the printed circuit board.

### BACKGROUND OF THE INVENTION

1. Field of the Invention

The present invention relates to a connecting structure for a USB (Universal Serial Bus), and more particularly to a connecting structure between a USB connector plugged into USB ports of computer units such as personal computers, notebooks and PDAs (Personal Digital Assistant) and a USB device is improved by enabling a printed circuit board fitted in the USB device and the USB connector to carry out their function even in the reversed position.

2. Description of the Prior Art

A USB interface is the most popular connecting means these days, and is known to include terminals, plugs, connectors and so on, which serve to connect USB devices such as memory sticks and wireless LAN cards to USB ports of personal computers, notebooks, PDAs and so on. As compared with the prior art, currently used personal computers require connection of a number of USB devices such as telephones, modems, printers, microphones, speakers, mice and scanners as various application programs are developed. To achieve such connection of USB devices and computer units, USB interfaces, which are convenient and excellent in functions, are currently used. Since the USB interfaces enable USB devices to be easily connected to computer units, and have functions such as hot plugging and Plug and Play, they have advantages in that users don't even need to shut down and restart their personal computers to connect USB devices to the computers.

In such connection, though prior art USB devices use a cable type USB interface as illustrated in FIG. 1, there are many cases these days where USB devices are directly connected to computers without a cable to obtain miniaturization of products. FIGS. 2 and 3 show examples of USB devices employing USB interfaces which are used currently, in which FIG. 2 shows a memory stick 200, and FIG. 3 shows a wireless LAN card.

In practice, the memory stick shown in FIG. 2 is connected to a computer unit, as illustrated in FIG. 4. More specifically, the memory stick 200 is connected to the computer unit 102 such that the memory stick is projected therefrom and is exposed to the outside. Hence, this memory stick structure is unstable and apt to be broken by external impact. To avoid such problems, a structure shown in FIG. 3 is used.

However, the structure shown in FIG. 3 will obstruct other terminals 100 of the computer unit 102 because the USB device 300 is extended laterally, as shown in FIG. 5. Accordingly, the structure of the USB device hinders use of other USB interfaces and thus causes considerable inconvenience in use. This problem is incurred by orientation of the structure of the USB interface, as shown in FIG. 6. That is, since an earth terminal 104, data terminals 105 and 106 and a power source terminal 107 are laterally arranged, the structure of the USB interface cannot be used in the reversed position and thus the structure can be used in only one orientation. Therefore, it is impossible to change the connecting orientation of the USB interface despite the fact that the USB device obstructs adjacent USB ports.

Furthermore, there is a case that USB devices to be plugged into the adjacent USB ports cannot be used due to the obstruction in the USB ports. Therefore, the present invention intends to enable a USB device to be used in the reversed position.

### SUMMARY OF THE INVENTION

Accordingly, the present invention has been made keeping in mind the above problems occurring in the prior art, and an object of the present invention is to provide a connecting structure for a USB which is designed to be used even in the reversed position so that when the connecting structure is plugged into its USB port, the other adjacent USB ports are not obstructed by the connecting structure.

In order to accomplish the above object, the present invention provides a connecting structure for a USB, comprising: a printed circuit board equipped in a USB device to be electrically connected to computer units such as personal computers, notebooks and PDAs, which is provided at its upper and lower surfaces with signal terminals such that the printed circuit board has the same arrangement as the signal terminals, regardless of whether the USB device is in a normal position or a reversed position; and a USB connector which is inserted into the USB device at its one end with the printed circuit board fitted into the USB connector, and is plugged into a USB port of the computer unit at its other end, the USB connector being provided at its one end with conductive strips corresponding to the signal terminals of the printed circuit board, and being provided at its other end with an input part to be plugged into the USB port of the computer unit.

The signal terminals formed on the upper surface of the printed circuit board may be arranged to be diagonally symmetrical to the signal terminals formed on the lower surface of the printed circuit board in section.

The conductive strips of the USB connector may be provided with V-shaped protrusions to afford close contact with the signal terminals of the printed circuit board.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a conventional USB device, which is adapted to be connected to a computer unit by a cable;

FIG. 2 is a perspective view showing an improved conventional USB device, which has no cable;

FIG. 3 is a plan view of another USB device, which is adapted to be directly connected to a computer unit;

FIG. 4 is a perspective view showing the USB device of FIG. 2, which is coupled to a computer unit;

FIG. 5 is a perspective view showing the USB device of FIG. 3, which is coupled to a computer unit;.

FIG. 6 is a perspective view showing a conventional USB connector which is connected to a printed circuit board of a USB device;

FIGS. 7a and 7b are exploded perspective views of a USB device connected to a computer unit according to the present invention, in which FIG. 7a shows a normal connection of the USB device and FIG. 7b shows a reverse connection of the USB device;

FIG. 8 shows a normal connection procedure of a printed circuit board and a USB connector using a connecting structure according to the present invention;

FIG. 9 shows a reverse connection procedure of a printed circuit board and a USB connector using a connecting structure according to the present invention;

FIG. 10 is a perspective view of a printed circuit board of a USB device according to the present invention;

FIGS. 11a and 11b show circuits formed on both surfaces of a printed circuit board of a USB device according to the present invention; and

FIG. 12 is a perspective view showing protrusions provided at a USB connector according to the present invention.

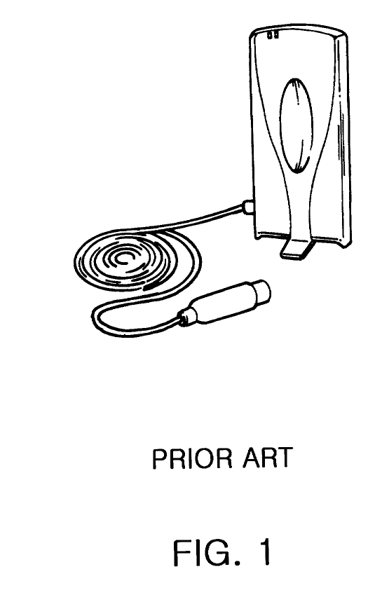

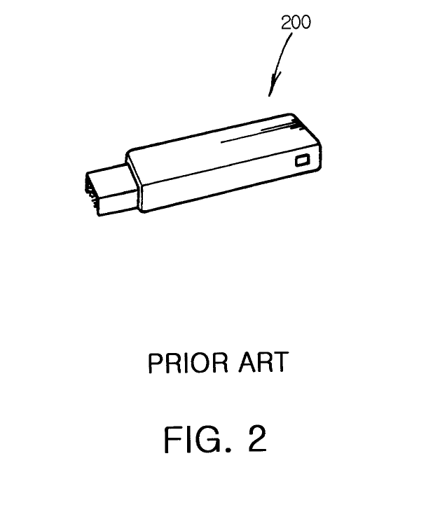

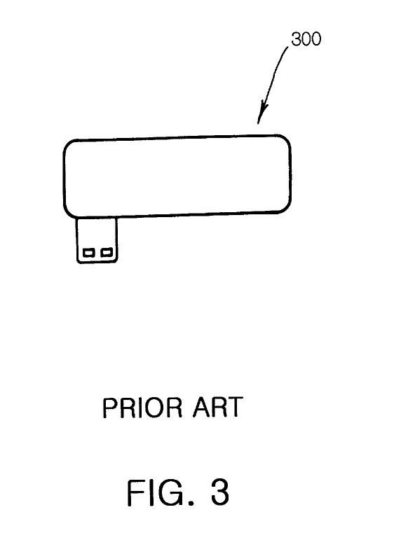

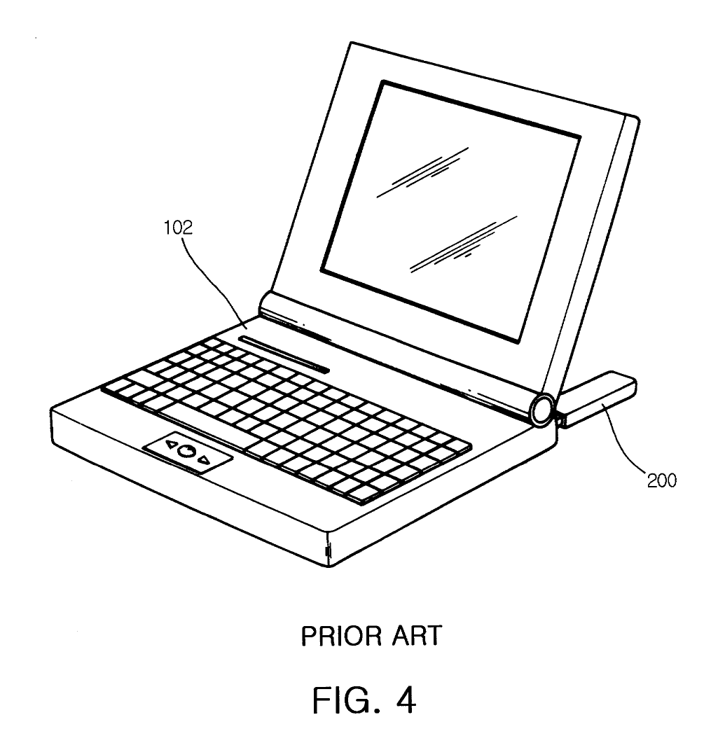

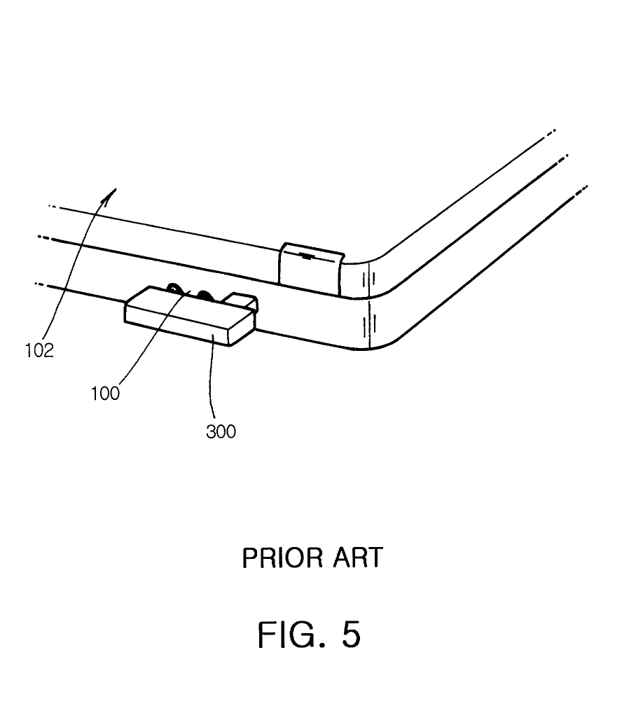

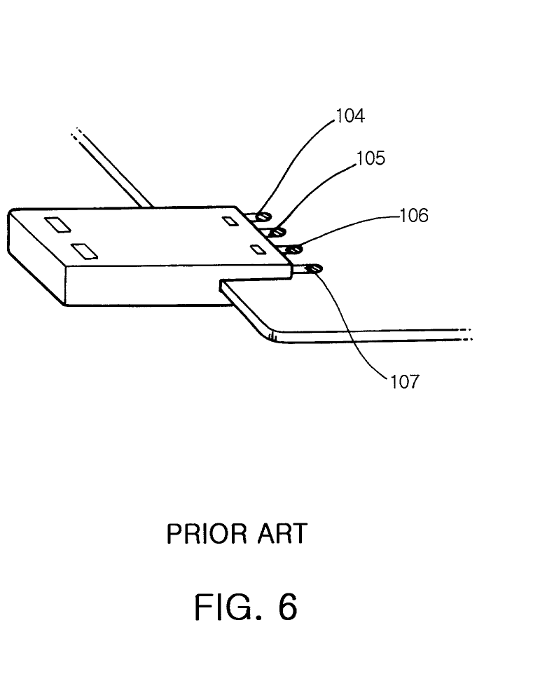

### DETAILED DESCRIPTION OF THE INVENTION

This invention will be described in further detail by way of example with reference to the accompanying drawings.

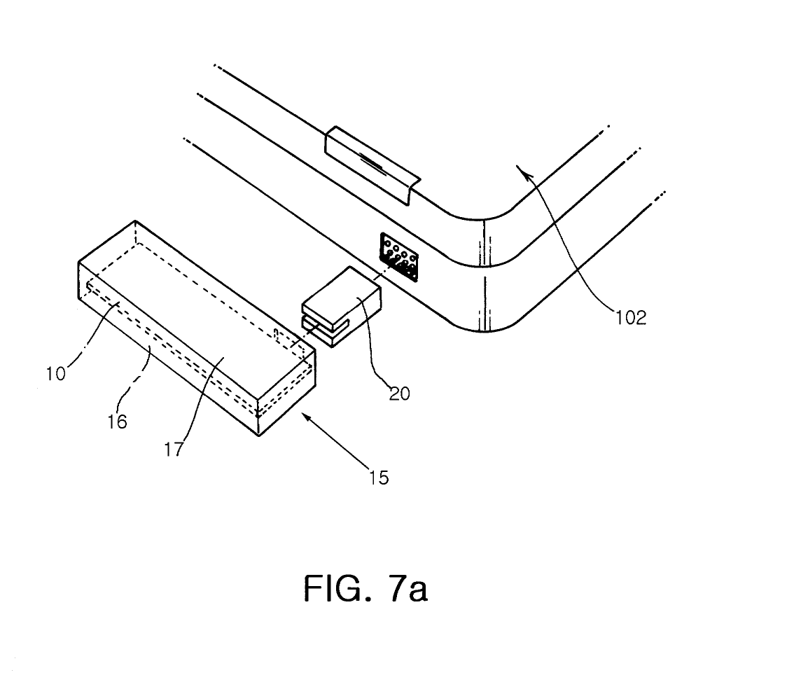

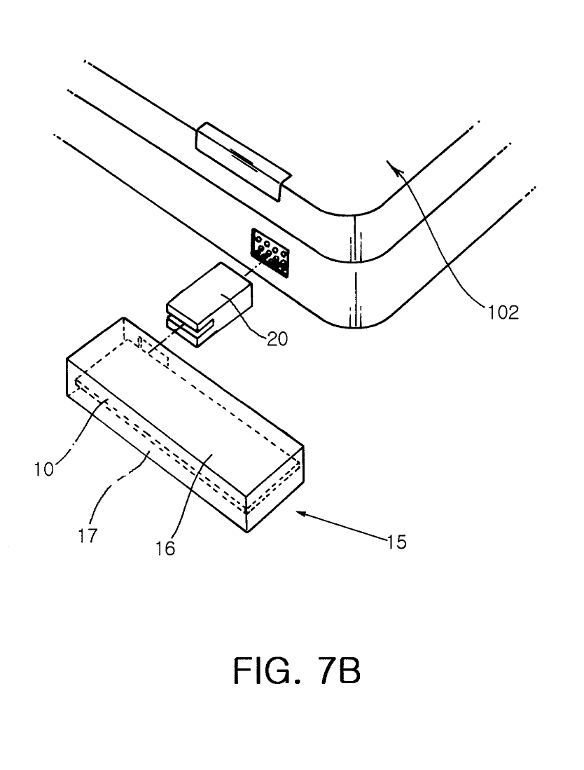

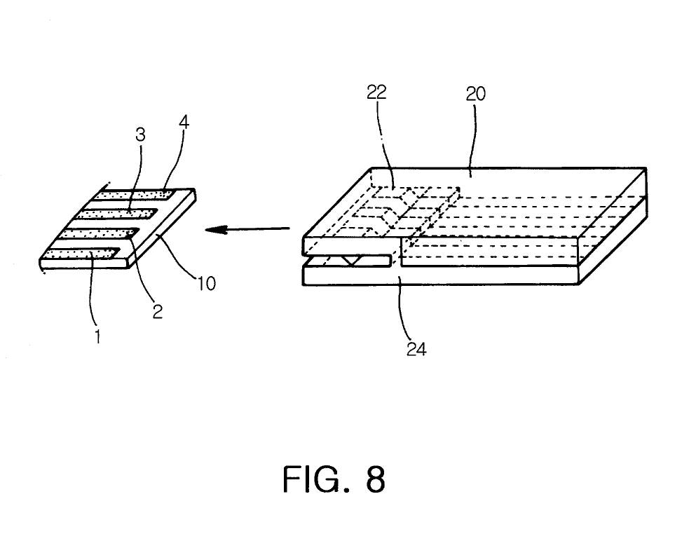

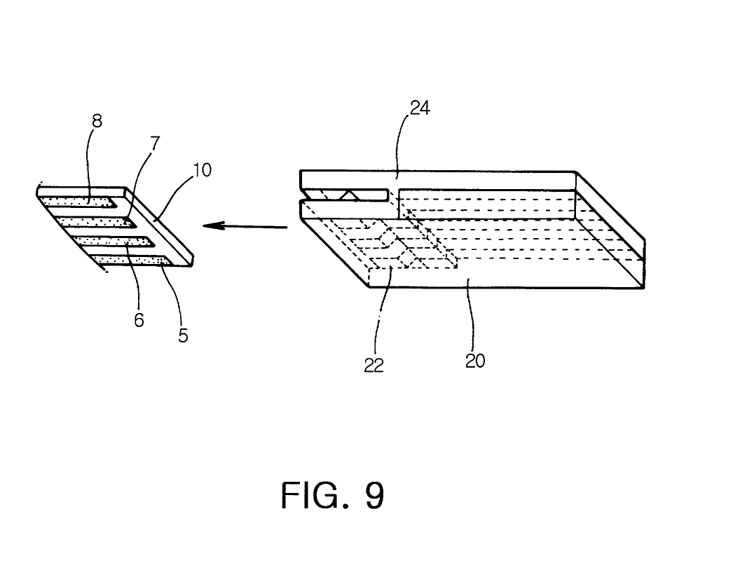

FIGS. 7a and 7b are exploded perspective views showing a connecting structure for a USB according to the present invention, in which a USB device is to be connected to a computer unit, FIG. 8 is a perspective view showing a connection of a printed circuit board and a USB connector using the connecting structure according to the present invention in a state of normal connection, and FIG. 9 is a perspective view showing a connection of the printed circuit board and the USB connector using the connecting structure according to the present invention in a state of reverse connection.

As shown in FIGS. 7a and 7b, a USB device 15 and a USB connector 20 to be plugged into a computer unit 102 can be connected to each other both in normal and reverse position by a connecting structure according to the present invention. FIG. 7a shows the USB device 15 which is normally connected to the USB connector 20 while FIG. 7b shows the USB device 15 which is reversely connected to the USB connector 20. From the drawings, it will be apparent that an upper surface 17 and a lower surface 16 of the USB device 15 shown in FIG. 7a are reversed in FIG. 7b.

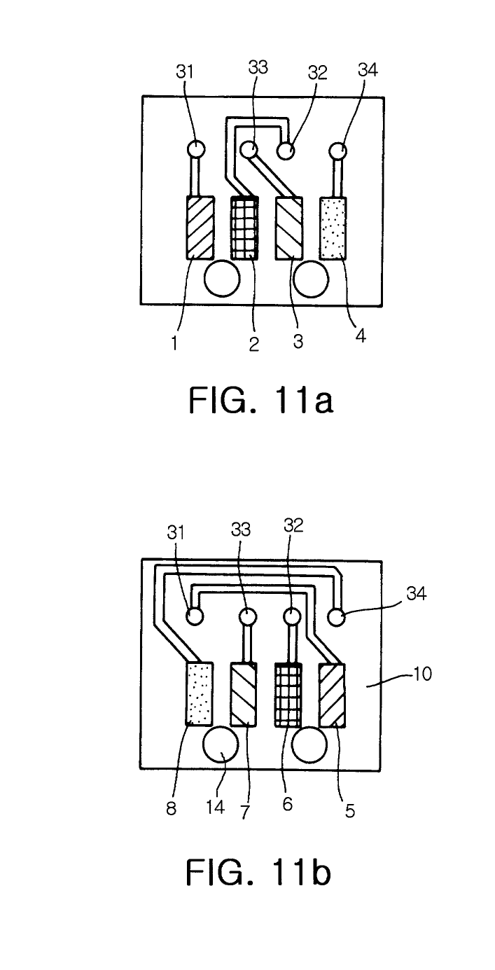

In connection of the USB device 15, when the USB device 15 is intended to be normally connected to the USB connector 20 in consideration of positional relation between the USB device 15 and USB ports of the computer unit 102, a printed circuit board of the USB device 15 is inserted into the USB connector 20 such that terminals 1 to 4 formed on an upper surface of the printed circuit board 10 come into electrical contact with conductive strips 22 of the USB connector 20, as shown in FIG. 8. At this point, the printed circuit board 10 cannot be separated from the USB connector 20 in such a way that the printed circuit board 10 is provided with retaining holes 14 (see FIG. 11), and an insulating body 24 of the USB connector 20 is provided with retaining protrusions 28. In this specification, the term “normal connection” as used herein means that terminals formed on the upper surface of the printed circuit board 10 are electrically connected the conductive strips of the USB connector 20.

When it is necessary to avoid the normal connection because the USB device 15 obstructs other USB ports than the corresponding USB port, the USB device 15 can be connected to the USB connector 20 in its reversed position by permitting terminals 5 to 8 formed on a lower surface of the printed circuit board 10 to be electrically connected to the conductive strips of the USB connector 20, as shown in FIG. 9. This connection is referred to as “reverse connection”. In the reverse connection, Only the lower terminals of the printed circuit board are connected to the conductive strips 22 of the USB connector 20, and the printed circuit board 10 can be securely held in the USB connector 20 by engagement of retaining holes 14 of the printed circuit board 10 and the retaining protrusions 28 of the USB connector 20, as is the case with the normal connection.

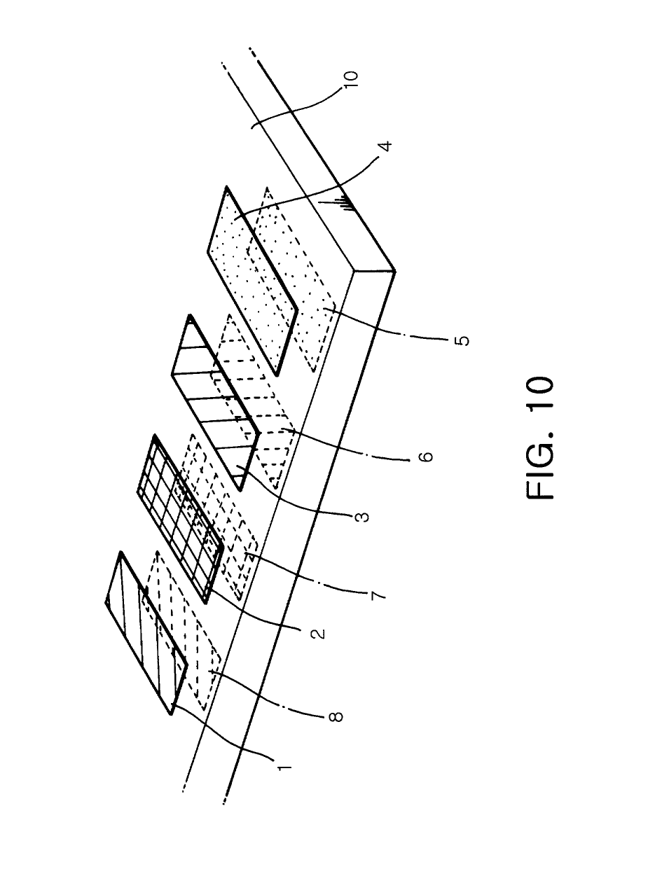

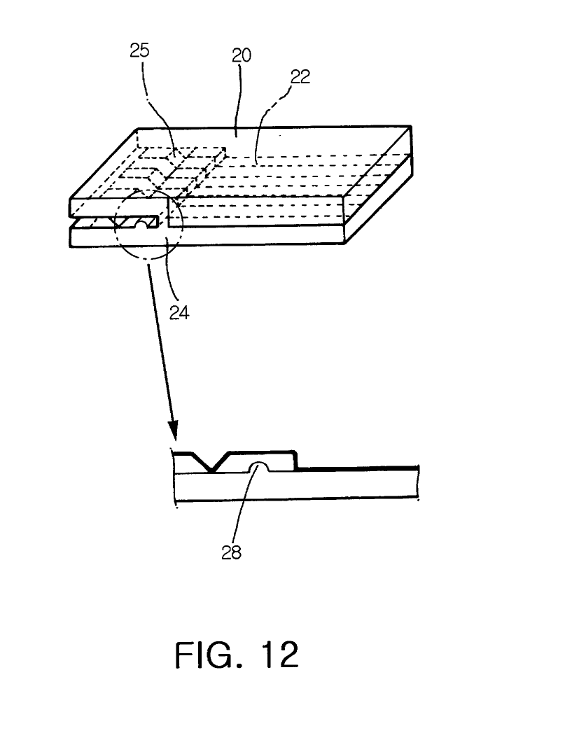

FIG. 10 shows the printed circuit board 10 of the USB device 15 for the connecting structure according to the present invention, FIGS. 11a and 11b show circuits formed on both surfaces of the printed circuit board 10 of the USB device 15 for constituting the connecting structure according to the present invention, and FIG. 12 is a perspective view showing a USB connector according to present invention.

As shown in FIG. 10, the printed circuit board 10 constituting the connecting structure for a USB according to the present invention is provided at its upper and lower surfaces with signal terminals 1 to 8 which serve to be connected to the USB connector. The printed circuit board 10 is incorporated in a USB device to be connected to a personal computer, a PDA and so on, and is shown to be a wireless modem in this embodiment. As shown in the drawing, the printed circuit board 10 is provided at its upper surface with an earth terminal 1, data terminals 2 and 3 and a power source terminal 4 and is also provided at its lower surface with an earth terminal 5, data terminals 6 and 7 and a power source terminal 8, so that the conductive strips of the USB connector can be always connected to the corresponding terminals, regardless of orientation of the printed circuit board 10. Accordingly, the upper terminals of the printed circuit board are positioned to be diagonally symmetrical to the lower terminals of the printed circuit board in section.

FIGS. 11a and 11b show circuits of a printed circuit board according to the present invention which is reversible in its orientation, in which FIG. 11a shows an upper circuit of the printed circuit board and FIG. 11b shows a lower circuit of the printed circuit board. Referring to the drawings, the printed circuit board is provided with the retaining holes 14 under the terminals and is provided with via-holes 31 to 34 above the terminals. The terminals of the printed circuit board must be connected to the via-holes such that the four pairs of terminals 1, 5; 2, 6; 3, 7; 4, 8 formed on the upper and lower surfaces are connected to the corresponding via-holes 31 to 34.

Therefore, it is preferable that the printed circuit board has a configuration shown in FIGS. 11a and 11b. Referring to FIG. 11a, the earth terminal 1 is connected to the earth via-hole 31 disposed thereabove, and the power source terminal 4 is connected to the power source via-hole 34 disposed thereabove. The data terminals 2 and 3 are connected to the corresponding data via-holes 32 and 33. Referring to FIG. 11b, the lower earth terminal 5 is connected to the earth via-hole 31, and the lower power source terminal 8 is connected to the power source via-hole 34. The lower data terminals 6 and 7 are also connected to the corresponding data via-holes 32 and 33. By this configuration, the printed circuit board can be provided at its both surface with terminals. The printed circuit board having this configuration is connected to the USB connector 20.

As shown in FIG. 12, the USB connector 20 is provided with conductive strips 22, which come into electrical contact with the corresponding terminals, and both side surfaces and a lower surface of the USB connector is formed of insulating material. The USB connector 20 are adapted to be plugged into a USB port of a computer unit (not shown) at its one end, and to be fitted on the printed circuit board 10 of a USB device 15 at the other end, as is the case with a known USB connector. In this case, the USB device 15 can be inserted into the USB connector 20, regardless of whether the USB device is in the normal position or the reversed position.

In the connecting structure according to the present invention, the conductive strips 22 of the USB connector 20 are partially formed with V-shaped protrusions 25, which serve to prevent gaps from forming between the conductive strips 22 and the terminals 1 to 8. To this end, the V-shaped protrusions 25 are shaped such that apexes of the V-shaped protrusions 25 are in close contact with the conductive strips.

In the connected condition of the printed circuit board and the USB connector, the retaining protrusions 28 formed on the insulating body 24 are inserted in the retaining holes 14 of the printed circuit board. The retaining protrusions 28 are provided in gaps under the conductive strips 22, and may be properly changed in their size and position in accordance with shapes of the retaining holes 14.

As described above, the present invention provides a connecting structure for a USB, which enables a printed circuit board of a USB device adopting a USB interface to be inserted into a USB connector plugged in a USB port of a computer unit, regardless of whether the USB device is in a normal position or in a reversed position, so that it is possible to prevent other USB ports of the computer unit from being obstructed by the USB device.

According to the present invention, the USB device can be applied to computer units, PDAs and so on which have USB ports arranged in various modes.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A connecting structure for a USB, comprising:
a printed circuit board equipped in a USB device to be electrically connected to computer units such as personal computers, notebooks and PDAS, which is provided at its upper and lower surfaces with signal terminals such that the printed circuit board has the same arrangement as the signal terminals, regardless of whether the USB device is in a normal position or a reversed position; and
a USB connector which is inserted into the USB device at its one end with the printed circuit board fitted into the USB connector, and is plugged into a USB port of the computer unit at its other end, the USB connector being provided at its one end with conductive strips corresponding to the signal terminals of the printed circuit board, and being provided at its other end with an input part to be plugged into the USB port of the computer unit.

2. The connecting structure for a USB as set forth in claim 1, in which the signal terminals formed on the upper surface of the printed circuit board are arranged to be diagonally symmetrical to the signal terminals formed on the lower surface of the printed circuit board in section.

3. The connecting structure for a USB as set forth in claim 2, in which the conductive strips of the USB connector are provided with V-shaped protrusions to afford close contact with the signal terminals of the printed circuit board.
